(19) United States
(12) Patent Application Publication
(10) Pub. No.: US 2008/0186432 A1
(43) Pub. Date: Aug. 7, 2008

(54) POLARIZING PLATE AND LIQUID CRYSTAL DISPLAY HAVING THE SAME

(75) Inventors: Myeong-Ha Kye, Seoul (KR); Seung Ju LEE, Gwangmyeong-si (KR); Yun JANG, Suwon-si (KR); Seung Hee LEE, Seoul (KR); Joon Hyung PARK, Seoul (KR); Kyoung Jin LEE, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/016,660

(22) Filed: Jan. 18, 2008

(30) Foreign Application Priority Data
Feb. 1, 2007 (KR) 10-2007-0010580

(51) Int. Cl. G02F 1/1335; G02B 1/04; G02B 5/30

(52) U.S. Cl. 349/96; 359/485

(57) ABSTRACT

In a liquid crystal display having a polarizing plate, the polarizing plate includes a polarizing film to polarize a light, a supporting film, and a surface film. The supporting film is arranged on the polarizing film and includes a scattering material to scatter the polarized light. The surface film is arranged on the supporting film. Thus, the liquid crystal display uses the light having uniform intensity to display the image.

### CROSS-REFERENCE TO RELATED APPLICATION

This application claims priority from and the benefit of Korean Patent Application No. 10-2007-0010580, filed on Feb. 1, 2007, which is hereby incorporated by reference for all purposes as if fully set forth herein.

### BACKGROUND OF THE INVENTION

1. Field of the Invention

The present invention relates to a display device. More particularly, the present invention relates to a polarizing plate that may be capable of improving display quality and a liquid crystal display employing the polarizing plate.

2. Discussion of the Background

In general, a liquid crystal display displays an image using liquid crystals. The liquid crystal display includes a liquid crystal panel having liquid crystals therein and a polarizing plate attached to the liquid crystal panel. The liquid crystals cause a phase shift of light passing through the liquid crystal panel according to their alignment. As a result, light either passes through the polarizing plate or is absorbed by the polarizing plate. The liquid crystal display adjusts the intensity of light passing through the polarizing plate by controlling the phase shift of the light and displays an image corresponding to the intensity of the light.

The polarizing plate includes a polarizing film and an optical film. The polarizing film polarizes light and the optical film performs various other functions. When light passes through the polarizing film and the optical film, the light polarized by the polarizing film may be scattered by the optical film. The light scattered by the optical film may not have uniform intensity in accordance with regions through which the light passes. As a result, a defect in which certain pixels are recognized as white dots may occur, thereby deteriorating the display quality of the liquid crystal display.

### SUMMARY OF THE INVENTION

The present invention provides a polarizing plate that may be capable of improving display quality.

The present invention also provides a liquid crystal display including the polarizing plate.

Additional features of the invention will be set forth in the description which follows, and in part will be apparent from the description, or may be learned by practice of the invention.

The present invention discloses a polarizing plate including a polarizing film to polarize a light, a supporting film arranged on the polarizing film and including a scattering material to scatter the polarized light, and a surface film arranged on the supporting film.

The present invention also discloses a liquid crystal display including a first substrate, a second substrate, a liquid crystal layer interposed between the first and second substrates, a first polarizing plate attached to an external surface of the first substrate, and a second polarizing plate attached to an external surface of the second substrate. The second polarizing plate includes a polarizing film to polarize a light, a supporting film arranged on the polarizing film and including a scattering material to scatter the polarized light, and a surface film arranged on the supporting film.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention, and together with the description serve to explain the principles of the invention.

FIG. 1 is a cross-sectional view showing a polarizing plate according to an exemplary embodiment of the present invention.

FIG. 2A and FIG. 2B are cross-sectional views showing an operational effect of the polarizing plate of FIG. 1.

FIG. 3 is a cross-sectional view showing a polarizing plate according to another exemplary embodiment of the present invention.

FIG. 4 is a cross-sectional view showing an operational effect of the polarizing plate of FIG. 3.

FIG. 5 is a cross-sectional view showing a polarizing plate according to another exemplary embodiment of the present invention.

FIG. 6 is a cross-sectional view showing a liquid crystal display according to an exemplary embodiment of the present invention.

FIG. 7 is an exploded perspective view showing a liquid crystal panel of FIG. 6.

FIG. 8A and FIG. 8B are cross-sectional views showing an operation of the liquid crystal display of FIG. 6.

FIG. 9 is a cross-sectional view showing a liquid crystal display according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

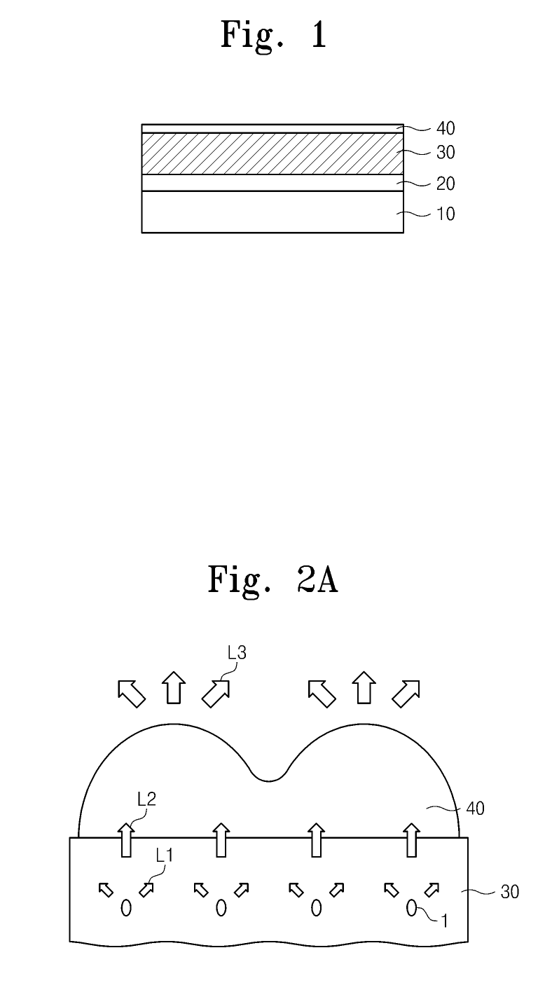

FIG. 1 is a cross-sectional view showing a polarizing plate according to an exemplary embodiment of the present invention.

Referring to FIG. 1, the polarizing plate includes a first supporting film 10, a polarizing film 20, a second supporting film 30, and a surface film 40. The first and second supporting films 10 and 30 face each other and the polarizing film 20 is interposed therebetween. The polarizing film 20 includes an optical film, which may include a polyvinyl alcohol compound. The polarizing film 20 may be formed by elongating the optical film into which iodine or dichroic dye may be incorporated. The polarizing film 20 has an absorption axis substantially parallel to the elongated direction.

The first and second supporting films 10 and 30 support the polarizing film 20. The first and second supporting films 10 and 30 may be durable to maintain the mechanical strength, the heat-resisting property, and the humidity-resisting property of the polarizing film 20. As an example of the present exemplary embodiment, the first and second supporting films 10 and 30 may include an optical film including a Tri-Acetate Cellulose (TAC) compound or a Cyclo-Olefin Polymer (COP) compound. Hereinafter, the optical film comprising the TAC compound is referred to as the first optical film and the optical film comprising the COP compound is referred to as the second optical film.

Both the polarizing film 20 and the first optical film are hydrophilic. As a result, the first optical film has a strong adhesive strength with respect to the polarizing film 20. In addition, although moisture may infiltrate into the interior of the polarizing film 20, the moisture may be easily removed from the interior to prevent the polarizing film 20 from malfunctioning. Meanwhile, the second optical film has superior strength and a low melting point, so the second supporting film 30 may be more easily fabricated.

As above described, since the first and second optical films have different advantages, the first and second supporting films 10 and 30 may have different advantages in accordance with combinations of the first and second optical films. For example, the first supporting film 10 may include the first optical film while the second supporting film 30 includes the second optical film. Alternatively, the first supporting film 10 may include the second optical film while the second supporting film 30 includes the first optical film. Further, both of the first and second supporting films 10 and 30 may include the first optical film or the second optical film.

The surface film 40 is formed on the second supporting film 30. The surface film 40 is provided as the uppermost layer of the polarizing plate and is outwardly exposed. The exposed face (hereinafter, referred to as external face) of the surface film 40 may be treated by anti-glare process.

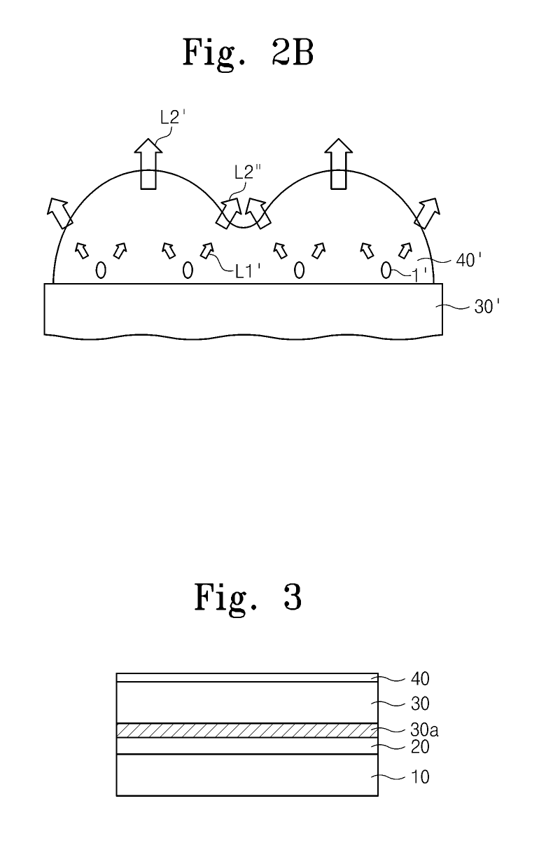

FIG. 2A and FIG. 2B are cross-sectional views showing an operational effect of the polarizing plate of FIG. 1.

Referring to FIG. 2A, the external face of the surface film 40 includes concavo-convex portions. The concavo-convex portions reflect light incident into the polarizing plate and scatter the reflected light in a lateral direction with respect to the polarizing plate. If the reflected light is concentrated in front of the polarizing plate, a viewer may not be able to recognize an image displayed on a liquid crystal display including the polarizing plate because the reflected light may cause a glare. The concavo-convex portions may reflect the light in the lateral direction, thereby preventing the glare and improving display quality.

The second supporting film 30 includes a scattering material 1 dispersed therein. The scattering material 1 includes particles comprising silicon oxide (SiO₂) or polymer beads.

A liquid crystal display employing the polarizing plate includes pixel areas to display an image thereon. The size of each pixel area may be small in order to display an image having higher resolution. Consequently, a pixel area may be positioned between two neighboring concavo-convex portions spaced apart from each other. In this case, if light passes through the pixel area, the light is not scattered by the concavo-convex portions, so the light may have an intensity greater than other light scattered by the concavo-convex portions. As a result, the image displayed at the pixel area between two neighboring concavo-convex portions may be brighter than the image displayed at other pixel areas, which may cause a glittering phenomenon and deteriorate the display quality of the liquid crystal display.

The scattering material 1 may scatter all light passing through the second supporting film 30 to prevent the glittering phenomenon of the displayed image. However, if the scattering material 1 is not adequately dispersed in the second supporting film 30, the glittering phenomenon may still occur as described below.

Referring to FIG. 2B, a polarizing plate includes a supporting film 30′ and a surface film 40′. The surface film 40′ includes a scattering material 1′ and concavo-convex portions in its external face. The scattering material 1′ is dispersed in an interior of the surface film 40′. The scattering material 1′ scatters light passing through the surface film 40′. The light L1′ scattered by the scattering material 1′ interferes with other scattered light to generate a first light L2′ and a second light L2″. The first light L2′ is generated by constructive interference and the second light L2″ is generated by destructive interference. Since the first light L2′ has an intensity greater than that of the second light L2″, an image corresponding to the first light L2′ may be brighter than an image corresponding to the second light L2″. Therefore, the image displayed by the first light L2′ may glitter, which may deteriorate the display quality of the liquid crystal display.

Referring again to FIG. 2A, the distance between the scattering material 1 and the concavo-convex portion is greater than that in a structure (refer to FIG. 2B) where the scattering material 1′ is dispersed in the interior of the surface film 40′. The light L1 is scattered by the scattering material 1 and interferes with other scattered light to generate an interfered light L2 while traveling through the space between the scattering material 1 and the concavo-convex portion. The interfered light L2 is formed by the constructive and destructive interferences of the scattered light L1 to have an average intensity due to the distance between the scattering material 1 and the concavo-convex portions. Therefore, the interfered light L2 may have uniform intensity over a whole region of the surface film 40.

The interfered light L2 passes through the surface film 40 and exits from the surface film 40. The light L3 that exits from the surface film 40 is dispersed in various directions by the concavo-convex portions formed on the surface film 40. Since the light L3 is generated from the interfered light L2 having uniform intensity, the light L3 may also have uniform intensity. As a result, the liquid crystal display employing the polarizing plate may display an image having uniform brightness and good display quality.

The second supporting film 30 may be formed through processes of melting, cooling, and extruding a raw material. For example, the scattering material 1 may be injected into melted raw material when the raw material is being cooled, so the scattering material 1 may be dispersed in the interior of the second supporting film 30. As described above, the second supporting film 30 may include the first optical film comprising the TAC compound or the second optical film comprising the COP compound. Since the COP compound has a melting point lower than that of the TAC compound, the second supporting film 30 may be formed using the second optical film in order to apply the above described processes to form the second supporting film 30.

FIG. 3 is a cross-sectional view showing another exemplary embodiment of a polarizing plate according to the present invention.

Referring to FIG. 3, the polarizing plate includes a first supporting film 10, a polarizing film 20, a scattering layer 30a, a second supporting film 30, and a surface film 40. The first and second supporting films 10 and 30 face each other and the polarizing film 20 and the scattering layer 30a are interposed therebetween. The polarizing film 20 includes an absorption axis and absorbs light substantially parallel to the absorption axis. The first and second supporting films 10 and 30 support the polarizing film 20 and may be durable to maintain the mechanical strength, the heat-resisting property, and the humidity-resisting property of the polarizing film 20. Each supporting film 10 and 30 may include the first optical film including the TAC compound or the second optical film including the COP compound.

The scattering layer 30a is formed between the polarizing film 20 and the second supporting film 30. The surface film 40 is formed on the second supporting film 30. The surface film 40 is provided as an uppermost layer of the polarizing plate to be outwardly exposed. An external face of the surface film 40 is treated by various processes, for example, by an anti-glare process.

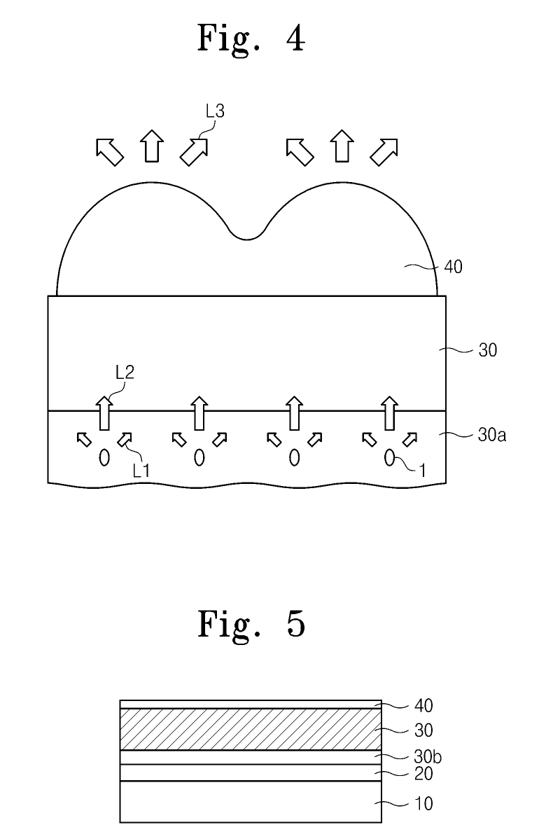

FIG. 4 is a cross-sectional view showing an operational effect of the polarizing plate of FIG. 3.

Referring to FIG. 4, the scattering layer 30a includes the scattering material 1 therein. The scattering layer 30a may include the first optical film including the TAC compound or the second optical film including the COP compound, and the scattering material 1 is dispersed in the interior of the scattering layer 30a. The scattering layer 30a may be formed using a separate optical film including the scattering material 1 and attaching the separate optical film to the second supporting film 30. The surface film 40 includes concavo-convex portions that reflect light incident into the polarizing plate in a lateral direction with respect to the polarizing plate, which may improve display quality.

The scattering material 1 may include particles comprising silicon oxide (SiO₂) or polymer beads. The scattering material 1 scatters light passing through the scattering layer 30a. The scattered light L1 interferes with other scattered light to generate an interfered light L2. Since the scattering material 1 and the concavo-convex portions are spaced apart from each other, the interfered light L2 is formed through the constructive and destructive interferences of the scattered light L1 to have an average intensity. Therefore, the interfered light L2 may have uniform intensity over a whole region of the surface film 40.

The interfered light L2 passes through the surface film 40 and exits from the surface film 40. The light L3 is dispersed in various directions by the concavo-convex portions formed on the surface film 40. Since the light L3 is generated from the interfered light L2 having uniform intensity, the light L3 may also have uniform intensity. As a result, the liquid crystal display including the polarizing plate may display an image having uniform brightness and good display quality.

FIG. 5 is a cross-sectional view showing another exemplary embodiment of a polarizing plate according to the present invention.

Referring to FIG. 5, the polarizing plate includes a first supporting film 10, a polarizing film 20, an electrostatic protecting layer 30b, a second supporting film 30, and a surface film 40. The first and second supporting films 10 and 30 face each other and the polarizing film 20 and the electrostatic protecting layer 30b are interposed therebetween. The polarizing film 20 includes an absorption axis and absorbs light substantially parallel to the absorption axis. The first and second supporting films 10 and 30 support the polarizing film 20, and each supporting film 10 and 30 may include the first optical film including the TAC compound or the second optical film including the COP compound.

The second supporting film 30 includes a scattering material that may be dispersed in the interior of the second supporting film 30. The scattering material includes particles comprising a silicon oxide (SiO₂) or polymer beads. The surface film 40 is formed on the second supporting film 30. The surface film 40 includes concavo-convex portions on its external face, and the external face of the surface film 40 may be treated by an anti-glare process. As described in the present exemplary embodiment, since the scattering material dispersed in the second supporting film 30 is spaced apart from the concavo-convex portions, light that exits from the polarizing plate may have uniform intensity. As a result, a liquid crystal display to which the polarizing plate is applied may display an image having uniform brightness and good display quality.

An electrostatic protecting layer 30b may be interposed between the polarizing film 20 and the second supporting film 30. The electrostatic protecting layer 30b may be treated by an anti-static process to include conductive particles within its interior. The electrostatic protecting layer 30b prevents static electricity from being generated in a liquid crystal display including the polarizing plate. As a result, the electrostatic protecting layer 30b may prevent malfunction of the liquid crystal display due to static electricity.

The electrostatic protecting layer 30b may be formed as a separate layer as in the present exemplary embodiment, or it may be omitted from the polarizing plate when conductive particles are positioned in the surface film 40. That is, if the surface film 40 includes conductive particles therein, the surface film 40 may prevent static electricity, and thus, a separate layer such as the electrostatic protecting layer 30b may not be necessary. Additionally, if the scattering material dispersed in the second supporting film 30 is conductive, a separate layer such as the electrostatic protecting layer 30b may not be necessary since the second supporting film 30 may be capable of preventing static electricity.

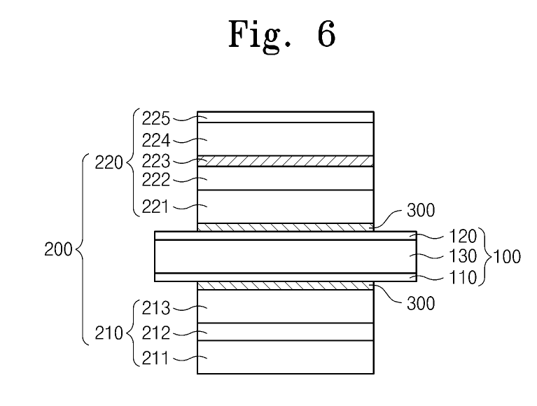

FIG. 6 is a cross-sectional view showing a liquid crystal display according an exemplary embodiment of to the present invention.

Referring to FIG. 6, the liquid crystal display includes a liquid crystal panel 100 and a polarizing plate 200. The liquid crystal panel 100 includes two substrates 110 and 120 facing each other and a liquid crystal layer 130 disposed between the two substrates 110 and 120. Hereinafter, in order to distinguish the two substrates 110 and 120 from each other, the substrate positioned below the liquid crystal layer 130 is referred to as the first substrate 110 and the substrate positioned in above the liquid crystal layer 130 is referred to as the second substrate 120.

The polarizing plate 200 is attached to external faces of the liquid crystal panel 100. The polarizing plate 200 includes a first polarizing plate 210 and a second polarizing plate 220. The first polarizing plate 210 is attached to an external face of the first substrate 110 and the second polarizing plate 220 is attached to an external face of the second substrate 120. The liquid crystal display further includes an adhesive layer 300 interposed between the liquid crystal panel 100 and the first polarizing plate 210 and between the liquid crystal panel 100 and the second polarizing plate 220. The adhesive layer 300 couples the first and second polarizing plates 210 and 220 to the first and second substrates 110 and 120, respectively. The liquid crystal panel 100 and the polarizing plate 200 coupled by the adhesive layer 300 may be detached from each other, if necessary. For example, if an operational error occurs when the polarizing plate 200 is attached to the liquid crystal panel 100, the polarizing plate 200 may be detached from the liquid crystal panel 100 and the liquid crystal panel 100 from which the polarizing plate 200 is detached may be reused.

The first polarizing plate 210 includes a first supporting film 211, a first polarizing film 212, and a second supporting film 213. The first and second supporting films 211 and 213 are opposite each other and the first polarizing film 212 is interposed therebetween to support the first polarizing film 212. The second polarizing plate 220 includes a third supporting film 221, a second polarizing film 222, a scattering layer 223, a fourth supporting film 224, and a surface film 225. The third and fourth supporting films 221 and 224 are opposite each other and the second polarizing film 222 and the scattering layer 223 are interposed therebetween to support the second polarizing film 222.

The first polarizing film 212 includes a first transmission axis to transmit light substantially parallel to the first transmission axis and absorb light substantially perpendicular to the first transmission axis. The second polarizing film 222 includes a second transmission axis substantially perpendicular to the first transmission axis to transmit light substantially parallel to the second transmission axis and absorb light substantially perpendicular to the second transmission axis. The scattering layer 223 includes a scattering material therein. The scattering material includes particles including silicon oxide (SiO₂) or polymer beads. The scattering layer 223 may be omitted from the polarizing plate if scattering material is dispersed in the second supporting film 224. The surface film 225 may include concavo-convex portions on its external face and may be treated by an anti-glare process. As described above with regard to the polarizing plate of the exemplary embodiment (refer to FIG. 4), since the scattering material dispersed in the scattering layer 223 may be spaced apart from the concavo-convex portions, the light that exits from the second polarizing plate 220 may have uniform intensity, which may improve the display quality of the image.

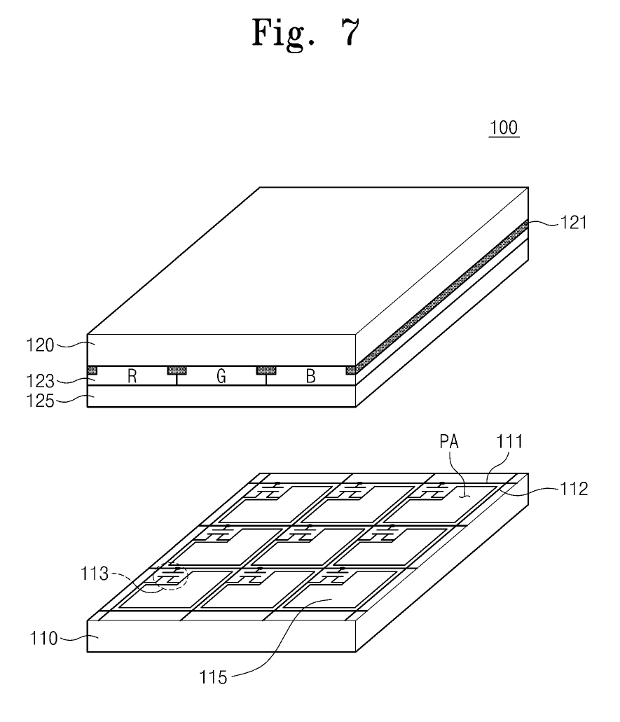

FIG. 7 is an exploded perspective view showing the liquid crystal panel of FIG. 6.

Referring to FIG. 7, the first substrate 110 includes a plurality of gate lines and a plurality of data lines. In the present exemplary embodiment, all of the gate lines have same structure and function, so only one gate line 111 will be explained as an example, and all of the data lines have also same structure and function, so only one data line 112 will be described as an example. The gate line 111 and the data line 112 are insulated from each other and cross each other to define a pixel area PA. In each pixel area PA, there is provided a thin film transistor 113 and a pixel electrode 115. The thin film transistor 113 includes a control electrode connected to the gate line 111, an input electrode connected to the data line 112, and an output electrode facing the input electrode. The pixel electrode 115 is connected to the output electrode.

The second substrate 120 includes a light blocking layer pattern 121, a color filter 123, and a common electrode 125. The light blocking layer pattern 121 is open in an area corresponding to each pixel area PA such that the light blocking layer pattern 121 is positioned between pixel areas PA. The color filter 123 is formed on the light blocking layer pattern 121 and fills the open areas of the light blocking layer pattern 121. The color filter 123 includes a red color filter R, a green color filter G, and a blue color filter B, which are sequentially arranged according to the pixel areas. The liquid crystal display uses combinations of the three color filters R, G, and B to display an image with various colors. The common electrode 125 is formed over the color filter 123.

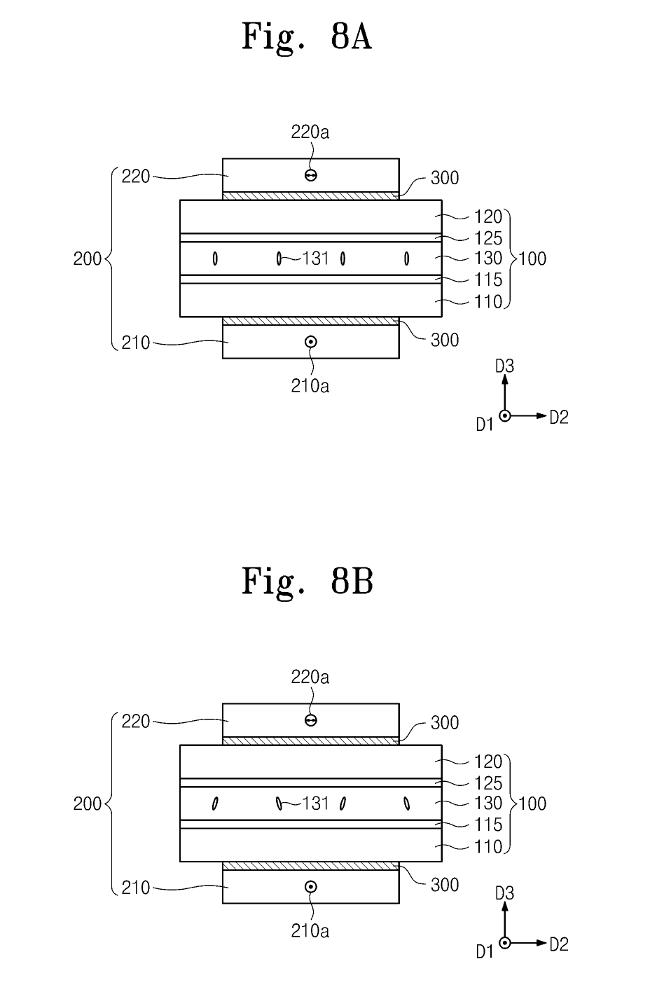

FIG. 8A and FIG. 8B are cross-sectional views showing an operation of the liquid crystal display of FIG. 6. In FIG. 8A and FIG. 8B, the polarizing plate is shown to provide better understanding of the operation.

Referring to FIG. 6, FIG. 7, and FIG. 8A, the liquid crystal display operates in two different states according to whether or not an electric field is applied to the liquid crystal layer 130. When an electric field is not applied to the liquid crystal layer 130, liquid crystals 131 of the liquid crystal layer 130 are aligned in a direction substantially perpendicular to the first and second substrates 110 and 120. The liquid crystals 131 have an oval shape with a long-axis and a short-axis, and the alignment of the liquid crystals 131 is defined by the direction of the long-axis.

Since the liquid crystals 131 are not self-emissive, the liquid crystal display requires a separate light source in order to display an image. The liquid crystal display may employ a backlight unit having a self-emissive element, such as a light emitting diode, as the light source. Otherwise, in lieu of light generated by the backlight unit, the liquid crystal display may use light incident from the outside into the liquid crystal display as the light source. In this case, the liquid crystal display reflects the incident light to display an image.

When a backlight unit is used as the light source, the liquid crystal display operates as follows. The backlight unit is arranged under the first polarizing plate 210 to generate the light. Hereinafter, the direction of the transmission axis of the first polarizing film 212 is defined as a first direction D1, and the direction of the transmission axis of the second polarizing film 222 is defined as a second direction D2, which is substantially perpendicular to the first direction D1. The light generated by the backlight unit travels in a third direction D3, which is substantially perpendicular to the first and second directions D1 and D2. The light is linearly polarized in the first direction D1 while passing through the first polarizing plate 210. The linearly polarized light passes through the liquid crystal layer 130 and enters the second polarizing plate 220. The linearly polarized light is absorbed by the second polarizing plate 220 and the liquid crystal display is in a black state.

Referring to FIG. 6, FIG. 7, and FIG. 8B, a gate signal and a data signal are transmitted through the gate line 111 and the data line 112, respectively. The gate signal allows the thin film transistor 113 to turn on, so that a data voltage corresponding to the data signal is applied to the pixel electrode 115 through data line 112. In addition, a constant common voltage is applied to the common electrode 125. Due to a voltage difference between the data voltage and the common voltage, an electric field is established between the first and second substrates 110 and 120. Responsive to the electric field, the liquid crystals 131 become aligned in an inclined direction with respect to the first and second substrates 110 and 120.

When the liquid crystals 131 are in this alignment state, the light provided by the backlight unit passes through the first polarizing plate 210 to be linearly polarized in the first direction D1. While the linearly polarized light passes through the liquid crystal layer 130, the phase of the light is shifted due to the liquid crystals 131, which are inclined to the first and second substrates 110 and 120. Since the phase-shifted light includes a light component (hereinafter, referred to as a second directional light) substantially parallel to the second direction D2, the phase-shifted light may pass through the second polarizing plate 220, so the liquid crystal display may be in a white state that is brighter than the black state.

In the present exemplary embodiment, the intensity of the second directional light varies according to the inclined angle of the liquid crystals 131, and the inclined angle of the liquid crystals 131 may be adjusted by controlling the intensity of the electric field. Since the second directional light is directly associated with the displayed image, an optical characteristic of the second directional light may be maintained while the second directional light travels from the liquid crystal layer 130 to the second polarizing film 222.

Therefore, the scattering layer 223, which scatters the second directional light to change the optical characteristic of the second directional light, is arranged on the second polarizing film 222. In addition, the first, second, third, and fourth supporting films 211, 213, 221, and 224 may not have any optical effect on the light passing therethrough, so the optical characteristic of the second directional light may be maintained in the third supporting film 221 positioned between the liquid crystal layer 130 and the second polarizing film 222.

The second and third supporting films 213 and 221 may serve as compensating films. The liquid crystals 131 have an anisotropic refractive index. Therefore, when the first and second lights pass through the liquid crystal layer 130 in the third direction D3 and in a predetermined direction inclined to the third direction D3, respectively, the phase shift of the first light is different from the phase shift of the second light. The liquid crystal display may be designed so that an image displayed in the third direction D3 corresponding to a front direction thereof is better than an image displayed in the predetermined direction corresponding to a lateral direction thereof. Therefore, the display quality in the lateral direction may be degraded by the difference between the phase shift of the first light and the phase shift of the second light. The compensating films compensate for this difference to improve the display quality in the lateral side direction and widen the viewing angle of the liquid crystal display. A compensating film, such as the second or third supporting film 213 and 221 may be arranged in at least one of the first and second substrates 210 and 220.

The compensating film may be formed by elongating an optical film in a predetermined direction. The compensating film may have an anisotropic refractive index corresponding to the elongated direction in order to compensate for the difference between the phase shifts of the first and second lights. Therefore, when at least one of the second and third supporting films 213 and 221 is applied to the polarizing plate as a compensating film, the elongating process may be further applied to form the second and third supporting film 213 and 221.

The first, second, third, and fourth supporting films 211, 213, 221, and 224 may include the first optical film including the TAC compound or the second optical film including the COP compound. The first optical film may have a high mechanical strength so it may be advantageous for the elongating process, and the second optical film may have a high adhesive strength with respect to the first and second polarizing films 212 and 222.

Therefore, when only one of the second and third supporting films 213 and 221 is used as the compensating film, the second optical film may be applied as the compensating film. In addition, when both the second and third supporting films 213 and 221 are used as compensating films both the first and second optical films may be applied as compensating films.

Since the first and fourth supporting films 211 and 224 do not need to have the optical properties required of a compensating film, the first and fourth supporting films 211 and 224 may be formed without the elongating process. Each supporting film 211, 213, 221, and 224 includes the first or second optical film. However, when the scattering layer 223 is removed from the second polarizing plate 220 and the fourth supporting film 224 includes the scattering material therein, the fourth supporting film 224 may include the COP compound having a melting point lower than that of the TAC compound, as described in the exemplary embodiment of the polarizing plate (refer to FIG. 1).

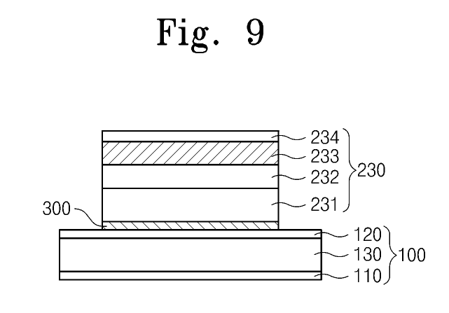

FIG. 9 is a cross-sectional view showing a liquid crystal display according to another exemplary embodiment of the present invention.

Referring to FIG. 9, the liquid crystal display includes a liquid crystal panel 100, and a polarizing plate 230. The liquid crystal panel 100 includes a first substrate 110, a second substrate 120, and a liquid crystal layer 130. The first and second substrates 110 and 120 face each other and the liquid crystal layer 130 is interposed therebetween. The polarizing plate 230 is attached to an upper surface of the liquid crystal panel 100. The liquid crystal display further includes an adhesive layer 300 interposed between the liquid crystal panel 100 and the polarizing plate 230 to couple the liquid crystal panel 100 with the polarizing plate 230.

The polarizing plate 230 includes a first supporting film 231, a polarizing film 232, a second supporting film 233, and a surface film 234. The first and second supporting films 231 and 233 support the polarizing film 232. The second supporting film 233 includes a scattering material therein to scatter a light. The surface film 234 may be treated by an anti-glare process to have concavo-convex portions on an external face thereof.

The liquid crystal display is provided with a reflective electrode on the first substrate 110. The reflective electrode reflects light incident from the outside into the liquid crystal display. The light reflected by the reflective electrode passes through the liquid crystal layer 130 and the polarizing plate 230 to display an image. The light reflected by the reflective electrode is scattered by the scattering material included in the second supporting film 223, and the light scattered by the scattering material is interfered with by other scattered light to have uniform intensity. The light having uniform intensity exits from the surface film 234 after passing through the surface film 234.

According to the above, light is scattered by the scattering material, so that the light may have uniform intensity. Further, the liquid crystal display uses the light having uniform intensity to display the image, which may improve the display quality of the image displayed thereon.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A polarizing plate, comprising:
a polarizing film to polarize a light;
a supporting film arranged on the polarizing film and comprising a scattering material to scatter the polarized light; and
a surface film arranged on the supporting film.

2. The polarizing plate of claim 1, wherein the scattering material is positioned in an interior of the supporting film.

3. The polarizing plate of claim 1, wherein the supporting film comprises:
a supporting layer; and
a light scattering layer comprising the scattering material and interposed between the supporting layer and the polarizing film.

4. The polarizing plate of claim 1, wherein the scattering material comprises particles comprising a silicon oxide.

5. The polarizing plate of claim 1, wherein the surface film comprises an external face that is treated by an anti-glare process.

6. The polarizing plate of claim 2, wherein the supporting film comprises a cyclo-olefin polymer compound.

7. The polarizing plate of claim 1, further comprising an opposite film facing the supporting film, the polarizing film being interposed between the supporting film and the opposite film.

8. The polarizing plate of claim 7, wherein the opposite film comprises a tri-acetate cellulose compound or a cyclo-olefin polymer compound.

9. A liquid crystal display comprising:
a first substrate;
a second substrate;
a liquid crystal layer interposed between the first substrate and the second substrate;
a first polarizing plate attached to an external surface of the first substrate; and
a second polarizing plate attached to an external surface of the second substrate, wherein the second polarizing plate comprises:
a polarizing film to polarize a light;
a supporting film arranged on the polarizing film and comprising a scattering material to scatter the polarized light; and
a surface film arranged on the supporting film.

10. The liquid crystal display of claim 9, wherein the scattering material is positioned in an interior of the supporting film.

11. The liquid crystal display of claim 9, wherein the supporting film of the second polarizing plate comprises:
a supporting layer; and
a light scattering layer comprising the scattering material and interposed between the supporting layer and the polarizing film.

12. The liquid crystal display of claim 9, wherein the scattering material comprises particles comprising a silicon oxide.

13. The liquid crystal display of claim 9, wherein an external face of the surface film is treated by an anti-glare process.

14. The liquid crystal display of claim 10, wherein the supporting film comprises a cyclo-olefin polymer compound.

15. The liquid crystal display of claim 9, further comprising an opposite film facing the supporting film, the polarizing film being interposed between the supporting film and the opposite film.

16. The liquid crystal display of claim 15, wherein the opposite film comprises a tri-acetate cellulose compound or a cyclo-olefin polymer compound.
